(19) United States
(12) Patent Application Publication
(10) Pub. No.: US 2026/0343442 A1
(43) Pub. Date: Oct. 29, 2026

(54) METHODS AND MECHANISMS OF SEPARATED SYNCHRONIZATION SIGNALS

(71) Applicant: Telefonaktiebolaget LM Ericsson (publ), Stockholm (SE)

(72) Inventors: Sina MALEKI, Malmö (SE); Pål FRENGER, Linköping (SE); Ali NADER, Malmö (SE); Andres REIAL, Höllviken (SE); Helka-Liina MÄÄTTÄNEN, Espoo (SE); Ajit NIMBALKER, Dublin, CA (US)

(21) Appl. No.: 19/487,843

(22) PCT Filed: May 30, 2024
(86) PCT No.: PCT/SE2024/050536

§ 371 Date: Nov. 25, 2025

Related U.S. Application Data
(60) Provisional application No. 63/505,198, filed on May 31, 2023.

(51) Int. Cl. H04W 56/00; H04W 48/12

(52) U.S. Cl. CPC H04W 56/001; H04W 48/12

(57) ABSTRACT

According to one aspect, a method in a wireless device (WD) configured to communicate with a network node. The WD and the network node are comprised in a network. The method includes accessing the network while one or both of the WD is in idle mode and the access is an initial access. Accessing the network is performed using a first synchronization signal (SS) and first system information associated with a first SS configuration (SSI) at least to enter a connected mode. The method also includes upon the WD entering the connected mode, obtaining one or more additional synchronization signal configurations (SSCs) that are one or both of self-sustaining and without a mandatory dependency and a mandatory relationship to one or both of the first SS and the SSI. Further, the method includes performing one or more actions based on the one or more SSCs.

### TECHNICAL FIELD

The present disclosure relates to wireless communications, and in particular, to synchronization signaling.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes (NNs), such as base stations, and mobile wireless devices (WD) (e.g., user equipment (UE)), as well as communication between network nodes and between WDs. The 3GPP is also developing standards for Sixth Generation (6G) wireless communication networks.

In NR, the NNs (e.g., gNBs) transmit both Primary Synchronization Signals (PSS) and Secondary Synchronization Signals (SSS). Based on the combination of PSS and SSS, the WD (e.g., UE) can identify the physical layer cell identity (PCI) and distinguish cells from each other. Furthermore, based on the SSS, the WD can perform measurements such as Reference Signal Received Power (RSRP), Reference Signal Received Quality (RSRQ), and Signal to Interference & Noise Ratio (SINR). The PSS/SSS, together with the Physical Broadcast Channel on which the Master Information Block (MIB) is transmitted, constitute the SS/PBCH block (SSB) occupying four Orthogonal Frequency Division Multiplex (OFDM) symbols. The MIB contains information to the WD which is necessary for accessing the cell.

Conventionally, NR SSB is a multi-purpose transmission used by the WDs for cell search, acquiring access-related information, cell timing, as well as Radio Resource Management (RRM) related measurements, e.g., mobility measurements, cell reselection, and also for connected mode Radio Link Monitoring (RLM), Beam Failure Detection (BFD), etc. Furthermore, it is expected by the WDs that at least all primary serving cells will transmit SSBs. When it comes to cell search, the WD expects the NN to transmit SSBs at least every 20 ms. The reason for this is that a WD that has been out of coverage may be able to find the cell with minimal delay. Nevertheless, for other purposes, and after connection, the WD can be configured to receive SSBs on shorter or longer periodicities up to 160 ms.

Further, a WD is typically configured to use SSBs not only for cell search but also several other purposes such as acquiring timing information, cell access related information, and measurement purposes, e.g., mobility measurements, cell reselection, RRM, RLM, BFD, etc. In most cases, the transmission of the SSBs at such high rates is redundant and reduces the practical implementation of longer periodicity SSBs which would otherwise enable the NN to utilize energy saving sleep opportunities. Furthermore, SSBs typically contain MIB which is mostly if not only used when the WD attempts to connect the cell, and it is for example not necessary for mobility measurements.

For connected mode, there are currently other reference signals such as the Channel state information reference signal (CSI-RS) that the NN may configure for measurements and link maintenance. The WD can then use the CSI-RS instead of the SSB for measurements/link maintenance. However, the CSI-RS cannot on itself serve such a purpose but has a Quasi Co-located (QCL) dependency/relation to SSB. The QCL information aids the WD with its channel, and frequency offset estimation and synchronization. As such, the NN may need to indicate via the Transmission Configuration Indicator (TCI) that a certain SSB is QCL with a certain CSI-RS. Also, in the typical framework, every SSB transmission needs to be accompanied by a QCL-matching system information (SI), random access, and paging transmissions, to cater to WDs for which a given SSB has the best quality.

Considering the increasing number of antennas and frequencies, this means an increasing number of synchronization signals, and if the current SSB mechanism is followed, this leads to a large increase in network energy consumption and practically diminishes the advantages of lean SSB transmissions initially planned in NR.

Therefore, there is a need to develop methods and mechanisms for purpose-based synchronization signal design.

### SUMMARY

Some embodiments advantageously provide methods, systems, and apparatuses for management of separated synchronization signals. In some embodiments, a method in a WD is described. The WD accesses the network (e.g., NN) in idle mode using a first synchronization signal (SS) (which may be referred to as SSI, or SS for idle) and system information, and, upon entering connected mode, the WD receives one or more additional synchronization signal configurations that are self-sustaining (i.e., without necessary/mandatory dependency/relationship (e.g., QCL relation) to the first synchronization signal).

In some other embodiments, the configuration of the additional synch signals can also be included partly or as a whole in the first system information. In some embodiments, the WD uses the second or additional synchronization signal configuration(s) (which may be referred to as SSC, or SS for connected) for measurements, as QCL reference, etc., for serving cell, and optionally for neighbor cells while in connected mode. In some other embodiments, the neighbor cell measurements are based on neighbor cell SS signals, either a first SS of the neighbor, or one of additional SSs such as SSC. In some embodiments, the SSC configuration (including SSN, synchronization signal for neighbor) may include a pointer (either statically or occasionally) to a previously provided SS configuration (e.g., the SSI, such as the SSB) or a separate SS configuration (e.g., a different or simplified design such as a lightweight SSB other SS design).

In some embodiments, separation of synchronization signals (SS) for different operational states and purposes enables the network (e.g., NN) to have leaner transmission of synchronization signals (when compared to conventional technologies), e.g., in time, frequency and space and thus achieve network energy savings. Furthermore, it can potentially provide more purpose-based SS for the WD, lowering the WD effort to search for SSs.

According to one aspect, a method in a wireless device (WD) configured to communicate with a network node. The WD and the network node are comprised in a network. The method includes accessing the network while one or both of the WD is in idle mode and the access is an initial access. Accessing the network is performed using a first synchronization signal (SS) and first system information associated with a first SS configuration (SSI) at least to enter a connected mode. The method also includes upon the WD entering the connected mode, obtaining one or more additional synchronization signal configurations (SSCs) that are one or both of self-sustaining and without a mandatory dependency and a mandatory relationship to one or both of the first SS and the SSI. Further, the method includes performing one or more actions based on the one or more SSCs.

In some embodiments, at least one of the one or more SSCs is included at least in part in the first system information.

In some other embodiments, one or more of: (A) the network is further accessed while one or both of a cell search is being performed by the WD and cell detection is being performed by the WD; (B) the one or more actions include performing measurements associated with one or both of a serving cell and a neighbor cell while in the connected mode and using at least one of the one more SSCs; (C) the WD is further configured to perform another action associated with the cell search and the cell detection; and (D) the measurements associated with the neighbor cell are based on neighbor cell synchronization signals including one of a first neighbor cell synchronization signal or an additional neighbor cell synchronization signal.

In some embodiments, at least one of the one or more SSCs includes a pointer to a previously provided synchronization signal configuration or a separate synchronization signal configuration.

In some other embodiments, the self-sustaining is related to one or more independent QCL relations.

In some embodiments, one or more of the SSI configures a synchronization signal (SS), the SS includes one or both of a primary SS (PSS) and a secondary SS (SSS), the SSI includes a field that points to broadcasted system information that includes information for performing the initial access, and the field is a one or both of a physical broadcast channel and a management information block field.

In some other embodiments, one or both of obtaining the one or more SSCs includes receiving the one or more SSCs from the network node and obtaining the one or more SSCs includes obtaining the one or more SSCs from additional system information other than the first system information.

In some embodiments, one or both of obtaining the one or more SSCs includes obtaining second system information and the one or more SSCs and the second system information correspond to connected mode operations.

In some other embodiments, at least one of the one or more SSCs include an information block.

In some embodiments, one or more of the one or more SSCs are associated with one or more physical signals, the one or more physical signals include a subset of a synchronization signal block (SSB), the subset includes one or more of a PSS, an SSS, and a physical broadcast channel, and the one or more physical signals include a channel state information reference signal (CSI-RS).

In some other embodiments, at least one of the SSCs one or more of: (A) is configured for a serving cell or a non-serving cell; (B) includes explicit signal configuration information; (C) includes a reference to the SSI; (D) is obtained in a first stage and a second stage, where in the first stage, multiple SSC configuration options are obtained, in the second stage, the obtaining includes receiving an indication indicating one or more of the multiple SSC configuration options; (E) is one of periodic, semi-static, and semi-persistent; and (F) is beamformed.

In some embodiments, performing the one or more actions include one or more of: (A) performing a mobility measurement based on at least one of the one or more SSCs; (B) performing reference signal received power (RSRP) measurement based on the at least one of the one or more SSCs; (C) performing periodic measurements based on a mobility parameter of the WD; and (D) transmitting to the network node assistance information related to SSC provisioning.

According to another aspect, a wireless device (WD) configured to communicate with a network node is described. The WD and the network node are comprised in a network. The WD is configured to access the network while one or both of the WD is in idle mode and the access is an initial access. Accessing the network is performed using a first synchronization signal (SS) and first system information associated with a first SS configuration (SSI) at least to enter a connected mode. The WD is also configured to upon the WD entering the connected mode, obtain one or more additional synchronization signal configurations (SSCs) that are one or both of self-sustaining and without a mandatory dependency and a mandatory relationship to one or both of the first SS and the SSI. Further, the WD is configured to perform one or more actions based on the one or more SSCs.

In some embodiments, at least one of the one or more SSCs is included at least in part in the first system information.

In some other embodiments, one or more of: (A) the network is further accessed while one or both of a cell search is being performed by the WD and cell detection is being performed by the WD; (B) the one or more actions include performing measurements associated with one or both of a serving cell and a neighbor cell while in the connected mode and using at least one of the one more SSCs; (C) the WD is further configured to perform another action associated with the cell search and the cell detection; and (D) the measurements associated with the neighbor cell are based on neighbor cell synchronization signals including one of a first neighbor cell synchronization signal or an additional neighbor cell synchronization signal.

In some embodiments, at least one of the one or more SSCs includes a pointer to a previously provided synchronization signal configuration or a separate synchronization signal configuration.

In some other embodiments, the self-sustaining is related to one or more independent QCL relations.

In some embodiments, one or more of the SSI configures a synchronization signal (SS), the SS includes one or both of a primary SS (PSS) and a secondary SS (SSS), the SSI includes a field that points to broadcasted system information that includes information for performing the initial access, and the field is a one or both of a physical broadcast channel and a management information block field.

In some other embodiments, one or both of obtaining the one or more SSCs includes receiving the one or more SSCs from the network node and obtaining the one or more SSCs includes obtaining the one or more SSCs from additional system information other than the first system information.

In some embodiments, one or both of obtaining the one or more SSCs includes obtaining second system information and the one or more SSCs and the second system information correspond to connected mode operations.

In some other embodiments, at least one of the one or more SSCs include an information block.

In some embodiments, one or more of the one or more SSCs are associated with one or more physical signals, the one or more physical signals include a subset of a synchronization signal block (SSB), the subset includes one or more of a PSS, an SSS, and a physical broadcast channel, and the one or more physical signals include a channel state information reference signal (CSI-RS).

In some other embodiments, at least one of the SSCs one or more of: (A) is configured for a serving cell or a non-serving cell; (B) includes explicit signal configuration information; (C) includes a reference to the SSI; (D) is obtained in a first stage and a second stage, where in the first stage, multiple SSC configuration options are obtained, in the second stage, the obtaining includes receiving an indication indicating one or more of the multiple SSC configuration options; (E) is one of periodic, semi-static, and semi-persistent; and (F) is beamformed.

In some embodiments, performing the one or more actions include one or more of: (A) performing a mobility measurement based on at least one of the one or more SSCs; (B) performing reference signal received power (RSRP) measurement based on the at least one of the one or more SSCs; (C) performing periodic measurements based on a mobility parameter of the WD; and (D) transmitting to the network node assistance information related to SSC provisioning.

According to one aspect, a method in a network node configured to communicate with a wireless device (WD) is described. The WD and the network node are comprised in a network. The method includes determining one or both of a first synchronization signal (SS) configuration (SSI) and one or more additional SS configurations (SSCs) based on one or more parameters, where the SSI is associated with a first SS and first system information used by the WD to access the network while one or both of the WD is in idle mode and the access is an initial access, and the accessing of the network is performed to enter a connected mode. The one or more SSCs are self-sustaining or without one or both of a mandatory dependency and a mandatory relationship to one or both of the first SS and the SSI. The method also includes upon determining that the WD has entered a connected mode, causing transmission of the one or more SSCs to the WD.

In some embodiments, at least one of the one or more SSCs is included at least in part in the first system information.

In some other embodiments, wherein at least one of the one or more SSCs includes a pointer to a previously provided synchronization signal configuration or a separate synchronization signal configuration.

In some embodiments, the self-sustaining is related to one or more independent QCL relations.

In some other embodiments, one or more of: (A) the network is further accessed while one or both of a cell search is being performed by the WD and cell detection is being performed by the WD; (B) the SSI configures a synchronization signal (SS); (C) the SS includes one or both of a primary SS (PSS) and a secondary SS (SSS); the SSI includes a field that points to broadcasted system information that includes information for performing the initial access; and (D) the field is a one or both of a physical broadcast channel and a management information block field.

In some embodiments, the method further includes transmitting additional system information other than the first system information for the WD to obtain the one or more SSCs.

In some other embodiments, one or both of transmitting the one or more SSCs includes transmitting second system information and the one or more SSCs and the second system information correspond to connected mode operations.

In some embodiments, at least one of the one or more SSCs include an information block.

In some other embodiments, one or more of: (A) the one or more SSCs are associated with one or more physical signals; (B) the one or more physical signals include a subset of a synchronization signal block (SSB); (C) the subset includes one or more of a PSS, an SSS, and a physical broadcast channel; and (D) the one or more physical signals include a channel state information reference signal (CSI-RS).

In some embodiments, at least one of the SSCs one or more of: (A) is configured for a serving cell or a non-serving cell; (B) includes explicit signal configuration information; (C) includes a reference to the SSI; (D) is transmitted to the WD in a first stage and a second stage, where in the first stage, multiple SSC configuration options are transmitted, and in the second stage, the transmission includes transmitting an indication indicating one or more of the multiple SSC configuration options; (E) is one of periodic, semi-static, and semi-persistent; and (F) is beamformed.

In some other embodiments, the method further includes one or more of: (A) performing or causing the WD to perform a mobility measurement based on at least one of the one or more SSCs; (B) performing or causing the WD to perform reference signal received power (RSRP) measurement based on the at least one of the one or more SSCs; (C) performing or causing the WD to perform periodic measurements based on a mobility parameter of the WD; and (D) receiving from the WD assistance information related to SSC provisioning.

According to another aspect, a network node configured to communicate with a wireless device (WD) is described. The WD and the network node are comprised in a network. The network node being configured to determine one or both of a first synchronization signal (SS) configuration (SSI) and one or more additional SS configurations (SSCs) based on one or more parameters, where the SSI is associated with a first SS and first system information used by the WD to access the network while one or both of the WD is in idle mode and the access is an initial access, and the accessing of the network is performed to enter a connected mode. The one or more SSCs are self-sustaining or without one or both of a mandatory dependency and a mandatory relationship to one or both of the first SS and the SSI. The network is also configured to, upon determining that the WD has entered a connected mode, cause transmission of the one or more SSCs to the WD.

In some embodiments, at least one of the one or more SSCs is included at least in part in the first system information.

In some other embodiments, wherein at least one of the one or more SSCs includes a pointer to a previously provided synchronization signal configuration or a separate synchronization signal configuration.

In some embodiments, the self-sustaining is related to one or more independent QCL relations.

In some other embodiments, one or more of: (A) the network is further accessed while one or both of a cell search is being performed by the WD and cell detection is being performed by the WD; (B) the SSI configures a synchronization signal (SS); (C) the SS includes one or both of a primary SS (PSS) and a secondary SS (SSS); the SSI includes a field that points to broadcasted system information that includes information for performing the initial access; and (D) the field is a one or both of a physical broadcast channel and a management information block field.

In some embodiments, the method further includes transmitting additional system information other than the first system information for the WD to obtain the one or more SSCs.

In some other embodiments, one or both of transmitting the one or more SSCs includes transmitting second system information and the one or more SSCs and the second system information correspond to connected mode operations.

In some embodiments, at least one of the one or more SSCs include an information block.

In some other embodiments, one or more of: (A) the one or more SSCs are associated with one or more physical signals; (B) the one or more physical signals include a subset of a synchronization signal block (SSB); (C) the subset includes one or more of a PSS, an SSS, and a physical broadcast channel; and (D) the one or more physical signals include a channel state information reference signal (CSI-RS).

In some embodiments, at least one of the SSCs one or more of: (A) is configured for a serving cell or a non-serving cell; (B) includes explicit signal configuration information; (C) includes a reference to the SSI; (D) is transmitted to the WD in a first stage and a second stage, where in the first stage, multiple SSC configuration options are transmitted, and in the second stage, the transmission includes transmitting an indication indicating one or more of the multiple SSC configuration options; (E) is one of periodic, semi-static, and semi-persistent; and (F) is beamformed.

In some other embodiments, the method further includes one or more of: (A) performing or causing the WD to perform a mobility measurement based on at least one of the one or more SSCs; (B) performing or causing the WD to perform reference signal received power (RSRP) measurement based on the at least one of the one or more SSCs; (C) performing or causing the WD to perform periodic measurements based on a mobility parameter of the WD; and (D) receiving from the WD assistance information related to SSC provisioning.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a wireless device according to some embodiments of the present disclosure;

FIG. 8 is a flowchart of an example process in a network node according to some embodiments of the present disclosure;

FIG. 9 is a flowchart of an example process in a wireless device according to some embodiments of the present disclosure;

FIG. 10 is a flowchart of an example process in a network node according to some embodiments of the present disclosure;

FIG. 11-14 show example QCL relations according to some embodiments of the present disclosure; and

FIG. 15 shows example synchronization signal configurations according to some embodiments of the present disclosure.

### DETAILED DESCRIPTION

Before describing in detail example embodiments, it is noted that the embodiments reside primarily in combinations of apparatus components and processing steps related to management of separated synchronization signals. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

In some embodiments, the term “SSI” (or SS for idle) is used and may refer to SS and/or configuration for the WD (and/or network node) where the configuration is associated with an idle state/mode of the WD. In some other embodiments, the term “SSC” (or SS for connected) is used and may refer to SS and/or configuration for the WD (and/or network node) where the configuration is associated with a connected state/mode of the WD. In some embodiments, the term “SSN” (or SS for neighbor cell or network node) is used and may refer to SS and/or configuration for the WD (and/or network node) where the configuration is associated with a neighbor cell or any other cell.

In some other embodiments, the term “self-sustaining” is used and may refer to a signal or configuration that is without necessary and/or mandatory dependency/relationship (e.g., QCL relation) another signal or another configuration.

In some embodiments, the term “pointer” is used and may refer to a reference or point or indication to a resource, location, bit, bit string, value, other pointer, etc. which may store a value, an object, information, a configuration, signal, etc. In some embodiments, a pointer may be used to perform a mapping from one reference to another (e.g., from a QCL reference to a physical signal such as PSS/SSS).

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

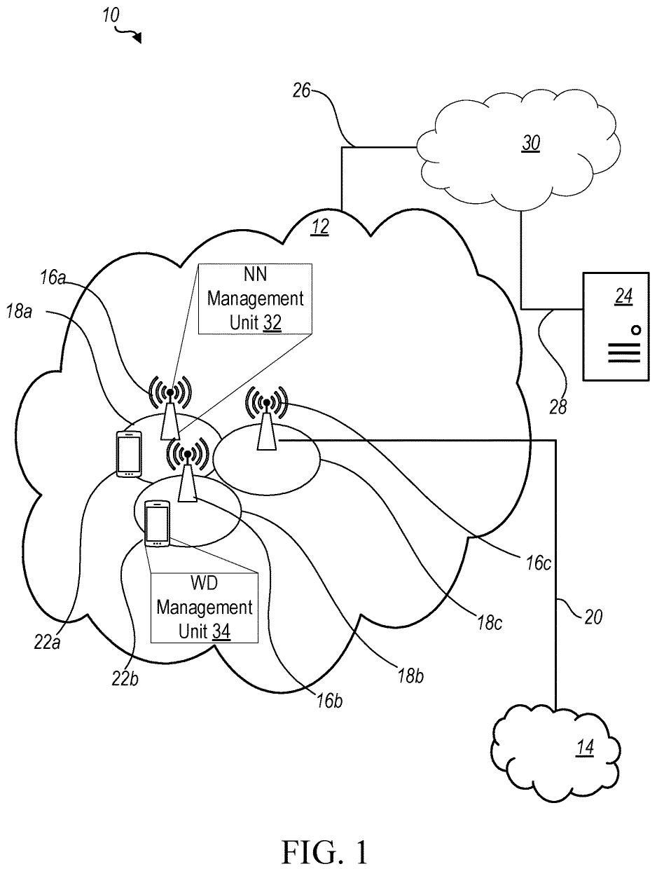

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). A coverage area 18 may be served by one or more wireless cells (hereinafter a cell). In some embodiments, coverage area 18 refers to one or more cells (i.e., cells 18). Thus, coverage area 18 may also be referred to as cell 18. Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a NN management unit 32 which is configured to perform any step and/or task and/or process and/or method and/or feature described in the present disclosure, e.g., NN functions. A wireless device 22 is configured to include a WD management unit 34 which is configured to perform any step and/or task and/or process and/or method and/or feature described in the present disclosure, e.g., WD functions.

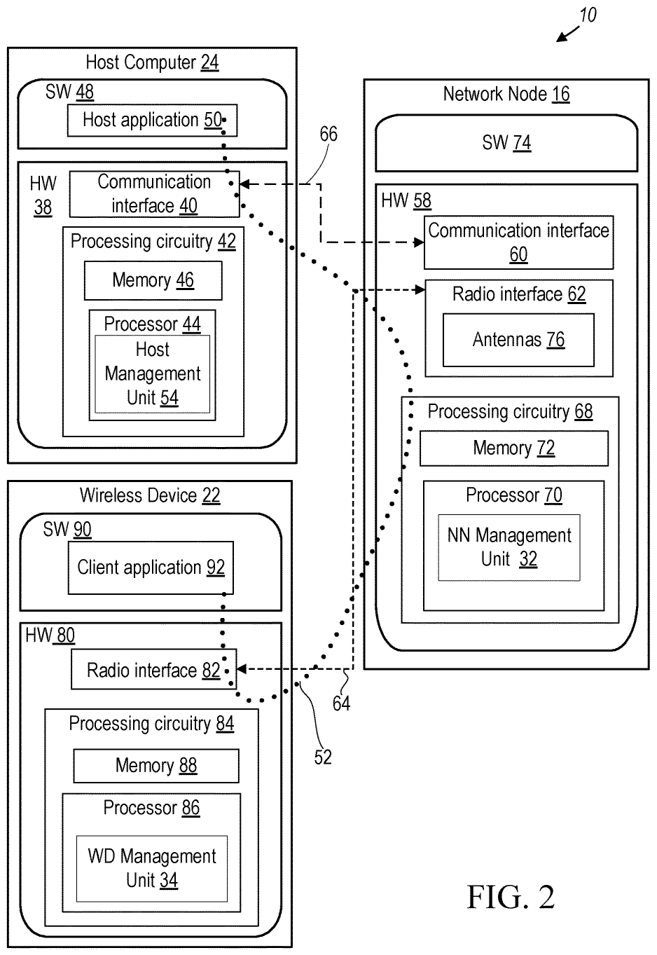

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22. The processing circuitry 42 of the host computer 24 may include a host management unit 54 configured to enable the service provider to observe/monitor/control/transmit to/receive from the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a NN management unit 32 which is configured to perform any step and/or task and/or process and/or method and/or feature described in the present disclosure, e.g., NN functions.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a WD management unit 34 which is configured to perform any step and/or task and/or process and/or method and/or feature described in the present disclosure, e.g., WD functions.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as NN management unit 32, and WD management unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

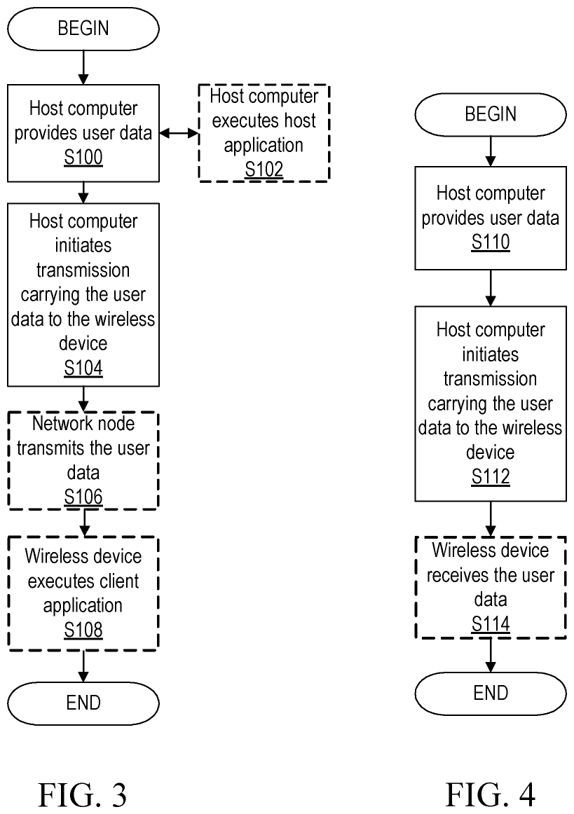

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

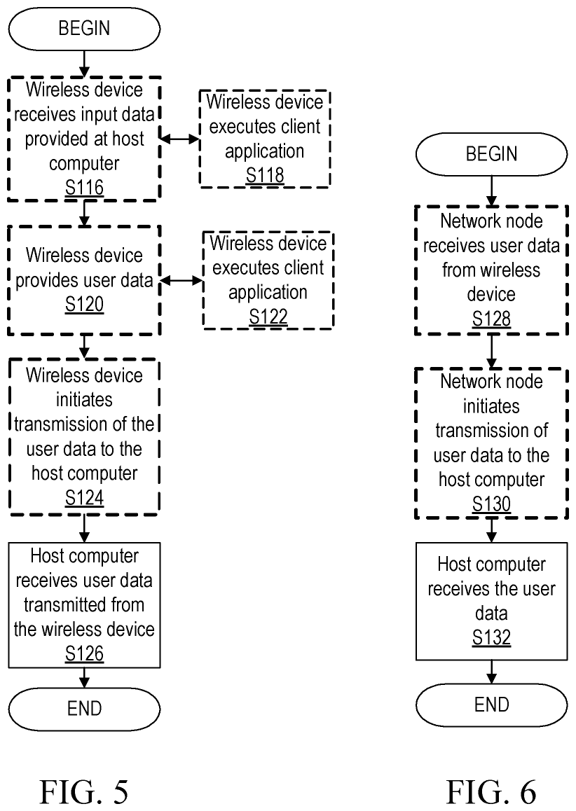

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

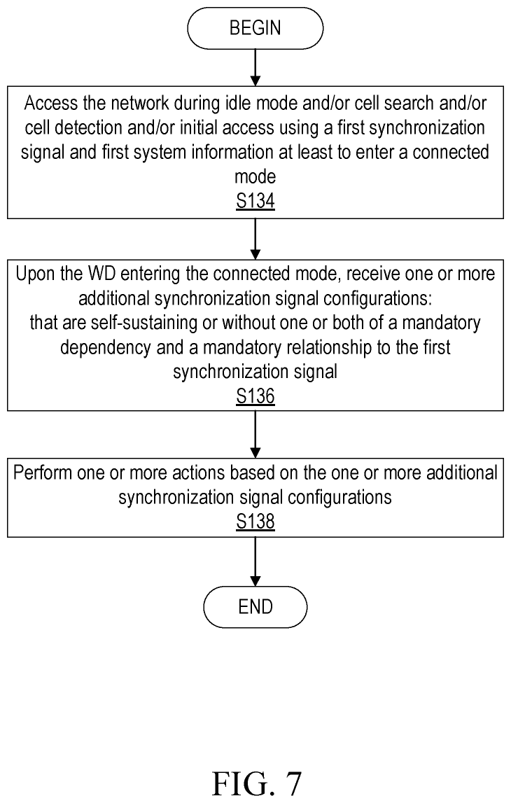

FIG. 7 is a flowchart of an example process in a wireless device 22 according to some embodiments of the present disclosure. One or more blocks described herein may be performed by one or more elements of wireless device 22 such as by one or more of processing circuitry 84 (including the WD management unit 34), processor 86, radio interface 82 and/or communication interface 60. Wireless device 22 is configured to access (Block S134) the network 12 during idle mode and/or cell search and/or cell detection and/or initial access using a first synchronization signal and first system information at least to enter a connected mode, upon the WD 22 entering the connected mode, receive (Block S136) one or more additional synchronization signal configurations that are self-sustaining or without one or both of a mandatory dependency and a mandatory relationship to the first synchronization signal, and perform (Block S138) one or more actions based on the one or more additional synchronization signal configurations.

In some embodiments, at least one of the one or more additional synchronization signal configurations is included at least in part in the first system information.

In some other embodiments, one or both of: the one or more actions include performing measurements associated with one or both of a serving cell 18 and a neighbor cell 18 while in the connected mode and using at least one of the one more additional synchronization signal configurations and the method further includes performing another action associated with the cell search and the cell detection.

In some embodiments, the measurements associated with the neighbor cell 18 are based on neighbor cell synchronization signals including one of a first neighbor cell synchronization signal or an additional neighbor cell synchronization signal.

In some other embodiments, at least one of the one or more additional synchronization signal configurations includes a pointer to a previously provided synchronization signal configuration or a separate synchronization signal configuration.

In some embodiments one or more of: the self-sustaining is related to independent QCL relations; the one or more additional synchronization signal configurations are without one or both of necessary dependency and necessary relationship to the first synchronization signal; the one or more additional signal configurations include another QCL relation to the first synch signal; the method further includes determining a QCL property between the first synchronization signal and the one or more additional synchronization signal configurations; and the method further includes receiving an indication indicating one or more of the independent QCL relations, the other QCL relation, the QCL property, the one or more additional synchronization signal configurations are without one or both of the necessary dependency and the necessary relationship to the first synchronization signal, the one or more additional synchronization signal configurations are without one or both of the mandatory dependency and the mandatory relationship to the first synchronization signal.

In some other embodiments, one or more of the method further includes receiving a second configuration to dynamically switch between different reference signals or one or more synchronization signals; the different reference signals include a synchronization signal block (SSB), the one or more additional synchronization signal configurations, and other reference signals; the first synchronization signal is usable for link and/or channel processing in the connected mode; the one or more synchronization signal configurations are usable for radio resource management and/or radio link monitoring; the first synchronization signal and/or the one or more synchronization signal configurations are periodically and/or semi-persistently transmitted by the network node 16; the method further includes receiving an indication about temporal usage of a group of synchronization for a predetermined purpose; the indication is one-shot, semi-persistent, or periodic with time-table-alike and/or with masking and/or precedence and/or priority and/or predetermined purpose information; and the indication indicates that overlapping or adjacent first synchronization signal occasions are to mask out synchronization signal configuration occasions and inherit or not inherit the predetermined purpose of the corresponding synchronization signal configuration occasion.

In some embodiments, the WD 22 accesses the network 12 via the network node 16, and the WD 22 is further configured to receive a first synchronization signal configuration and the one or more additional synchronization signal configurations from the network node 16.

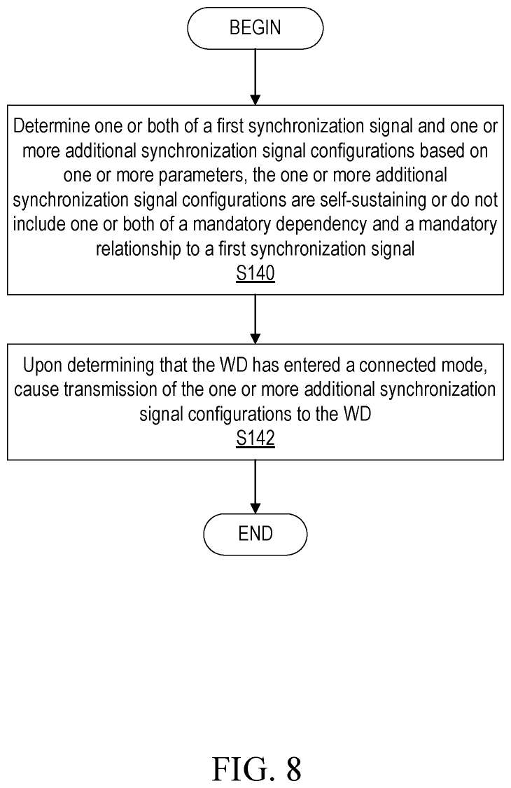

FIG. 8 is a flowchart of an example process in a network node 16. One or more blocks described herein may be performed by one or more elements of network node 16 such as by one or more of processing circuitry 68 (including the NN management unit 32), processor 70, radio interface 62 and/or communication interface 60. Network node 16 is configured to determine (Block S140) one or both of a first synchronization signal and one or more additional synchronization signal configurations based on one or more parameters, where the one or more additional synchronization signal configurations are self-sustaining or do not include one or both of mandatory dependency and mandatory relationship to a first synchronization signal, and upon determining that the WD 22 has entered a connected mode, cause (Block S142) transmission of the one or more additional synchronization signal configurations to the WD 22.

In some embodiments, the WD 22 accesses the network 12 during idle mode and/or cell search and/or cell detection and/or initial access using the first synchronization signal and first system information at least to enter the connected mode, and at least one of the one or more additional synchronization signal configurations is included at least in part in the first system information.

In some other embodiments, one or both of the transmission of the one or more additional synchronization signal configurations triggers the WD 22 to perform measurements associated with one or both of a serving cell 18 and a neighbor cell 18 while in the connected mode and using at least one of the one more additional synchronization signal configurations; and the WD 22 is configured to perform an action associated with the cell search and the cell detection.

In some embodiments, the measurements associated with the neighbor cell 18 are based on neighbor cell synchronization signals including one of a first neighbor cell synchronization signal or an additional neighbor cell synchronization signal.

In some other embodiments, at least one of the one or more additional synchronization signal configurations includes a pointer to a previously provided synchronization signal configuration or a separate synchronization signal configuration.

In some embodiments, one or more of the self-sustaining is related to independent QCL relations; the one or more additional synchronization signal configurations are without one or both of necessary dependency and necessary relationship to the first synchronization signal; the one or more additional signal configurations include another QCL relation to the first synch signal; the method further includes causing the WD to determine a QCL property between the first synchronization signal and the one or more additional synchronization signal configurations; and/or the method further includes transmitting an indication indicating one or more of the independent QCL relations, the other QCL relation, the QCL property, the one or more additional synchronization signal configurations are without one or both of the necessary dependency and the necessary relationship to the first synchronization signal, the one or more additional synchronization signal configurations are without one or both of the mandatory dependency and the mandatory relationship to the first synchronization signal.

In some other embodiments, one or more of the method further includes transmitting a second configuration to dynamically switch between different reference signals or one or more synchronization signals; the different reference signals include a synchronization signal block (SSB), the one or more additional synchronization signal configurations, and other reference signals; the first synchronization signal is usable for link and/or channel processing in the connected mode; the one or more synchronization signal configurations are usable for radio resource management and/or radio link monitoring; the first synchronization signal and/or the one or more synchronization signal configurations are periodically and/or semi-persistently transmitted by the network node; the method further includes transmitting an indication about temporal usage of a group of synchronization for a predetermined purpose; the indication is one-shot, semi-persistent, or periodic with time-table-alike and/or with masking and/or precedence and/or priority and/or predetermined purpose information; and/or the indication indicates that overlapping or adjacent first synchronization signal occasions are to mask out synchronization signal configuration occasions and inherit or not inherit the predetermined purpose of the corresponding synchronization signal configuration occasion.

In some embodiments, the WD 22 accesses the network 12 via the network node 16, and the network node 16 is further configured to transmit a first synchronization signal configuration and the one or more additional synchronization signal configurations to the WD 22.

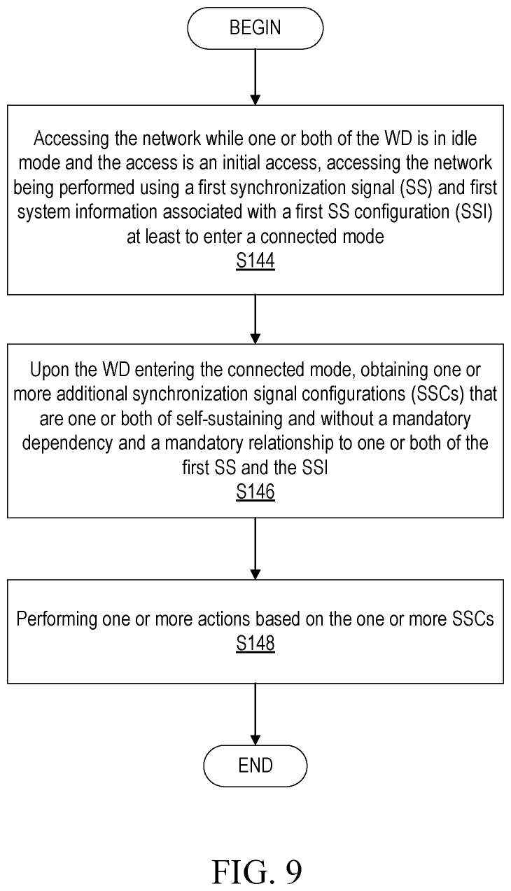

FIG. 9 is a flowchart of an example process in a WD 22 according to some embodiments of the present disclosure. One or more blocks described herein may be performed by one or more elements of WD 22 such as by one or more of processing circuitry 84 (including the WD management unit 34), processor 86, radio interface 82 and/or communication interface 60. WD 22 is configured to access (Block S144) the network 12, 14, 30 while one or both of the WD 22 is in idle mode and the access is an initial access. Accessing the network 12, 14, 30 is performed using a first synchronization signal (SS) and first system information associated with a first SS configuration (SSI) at least to enter a connected mode. WD 22 is also configured to upon the WD 22 entering the connected mode, obtain (Block S146) one or more additional synchronization signal configurations (SSCs) that are one or both of self-sustaining and without a mandatory dependency and a mandatory relationship to one or both of the first SS and the SSI. Further, WD 22 is configured to perform (Block S148) one or more actions based on the one or more SSCs.

In some embodiments, at least one of the one or more SSCs is included at least in part in the first system information.

In some other embodiments, one or more of: (A) the network 12, 14, 30 is further accessed while one or both of a cell search is being performed by the WD 22 and cell detection is being performed by the WD 22; (B) the one or more actions include performing measurements associated with one or both of a serving cell 18 and a neighbor cell 18 while in the connected mode and using at least one of the one more SSCs; (C) the WD 22 is further configured to perform another action associated with the cell search and the cell detection; and (D) the measurements associated with the neighbor cell are based on neighbor cell synchronization signals including one of a first neighbor cell synchronization signal or an additional neighbor cell synchronization signal.

In some embodiments, at least one of the one or more SSCs includes a pointer to a previously provided synchronization signal configuration or a separate synchronization signal configuration.

In some other embodiments, the self-sustaining is related to one or more independent QCL relations.

In some embodiments, one or more of the SSI configures a synchronization signal (SS), the SS includes one or both of a primary SS (PSS) 204 and a secondary SS (SSS) 204, the SSI includes a field that points to broadcasted system information that includes information for performing the initial access, and the field is a one or both of a physical broadcast channel and a management information block field.

In some other embodiments, one or both of obtaining the one or more SSCs includes receiving the one or more SSCs from the network node 16 and obtaining the one or more SSCs includes obtaining the one or more SSCs from additional system information other than the first system information.

In some embodiments, one or both of obtaining the one or more SSCs includes obtaining second system information and the one or more SSCs and the second system information correspond to connected mode operations.

In some other embodiments, at least one of the one or more SSCs include an information block.

In some embodiments, one or more of the one or more SSCs are associated with one or more physical signals, the one or more physical signals include a subset of a synchronization signal block (SSB), the subset includes one or more of a PSS 204, an SSS 204, and a physical broadcast channel, and the one or more physical signals include a channel state information reference signal (CSI-RS).

In some other embodiments, at least one of the SSCs one or more of: (A) is configured for a serving cell 18 or a non-serving cell 18; (B) includes explicit signal configuration information; (C) includes a reference to the SSI; (D) is obtained in a first stage and a second stage, where in the first stage, multiple SSC configuration options are obtained, in the second stage, the obtaining includes receiving an indication indicating one or more of the multiple SSC configuration options; (E) is one of periodic, semi-static, and semi-persistent; and (F) is beamformed.

In some embodiments, performing the one or more actions include one or more of: (A) performing a mobility measurement based on at least one of the one or more SSCs; (B) performing reference signal received power (RSRP) measurement based on the at least one of the one or more SSCs; (C) performing periodic measurements based on a mobility parameter of the WD 22; and (D) transmitting to the network node 16 assistance information related to SSC provisioning.

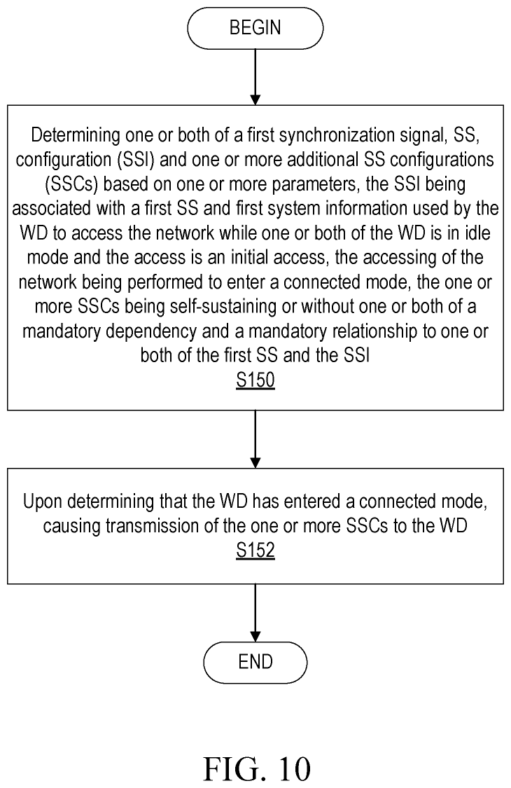

FIG. 10 is a flowchart of an example process in a network node 16. One or more blocks described herein may be performed by one or more elements of network node 16 such as by one or more of processing circuitry 68 (including the NN management unit 32), processor 70, radio interface 62 and/or communication interface 60. Network node 16 is configured to determine (Block S150) one or both of a first synchronization signal (SS) configuration (SSI) and one or more additional SS configurations (SSCs) based on one or more parameters, where the SSI is associated with a first SS and first system information used by the WD 22 to access the network 12, 14, 30 while one or both of the WD 22 is in idle mode and the access is an initial access, and the accessing of the network 12, 14, 30 is performed to enter a connected mode. The one or more SSCs are self-sustaining or without one or both of a mandatory dependency and a mandatory relationship to one or both of the first SS and the SSI. Network node 16 is also configured to upon determining that the WD 22 has entered a connected mode, cause (Block S152) transmission of the one or more SSCs to the WD 22.

In some embodiments, at least one of the one or more SSCs is included at least in part in the first system information.

In some other embodiments, wherein at least one of the one or more SSCs includes a pointer to a previously provided synchronization signal configuration or a separate synchronization signal configuration.

In some embodiments, the self-sustaining is related to one or more independent QCL relations.

In some other embodiments, one or more of: (A) the network 12, 14, 30 is further accessed while one or both of a cell search is being performed by the WD 22 and cell detection is being performed by the WD 22; (B) the SSI configures a synchronization signal (SS); (C) the SS includes one or both of a primary SS (PSS) 204 and a secondary SS (SSS) 204; the SSI includes a field that points to broadcasted system information that includes information for performing the initial access; and (D) the field is a one or both of a physical broadcast channel and a management information block field.

In some embodiments, the method further includes transmitting additional system information other than the first system information for the WD 22 to obtain the one or more SSCs.

In some other embodiments, one or both of transmitting the one or more SSCs includes transmitting second system information and the one or more SSCs and the second system information correspond to connected mode operations.

In some embodiments, at least one of the one or more SSCs include an information block.

In some other embodiments, one or more of: (A) the one or more SSCs are associated with one or more physical signals; (B) the one or more physical signals include a subset of a synchronization signal block (SSB); (C) the subset includes one or more of a PSS 204, an SSS 204, and a physical broadcast channel; and (D) the one or more physical signals include a channel state information reference signal (CSI-RS).

In some embodiments, at least one of the SSCs one or more of: (A) is configured for a serving cell 18 or a non-serving cell 18; (B) includes explicit signal configuration information; (C) includes a reference to the SSI; (D) is transmitted to the WD 22 in a first stage and a second stage, where in the first stage, multiple SSC configuration options are transmitted, and in the second stage, the transmission includes transmitting an indication indicating one or more of the multiple SSC configuration options; (E) is one of periodic, semi-static, and semi-persistent; and (F) is beamformed.

In some other embodiments, the method further includes one or more of: (A) performing or causing the WD 22 to perform a mobility measurement based on at least one of the one or more SSCs; (B) performing or causing the WD 22 to perform reference signal received power (RSRP) measurement based on the at least one of the one or more SSCs; (C) performing or causing the WD 22 to perform periodic measurements based on a mobility parameter of the WD 22; and (D) receiving from the WD assistance information related to SSC provisioning.

Having described the general process flow of arrangements of the disclosure and having provided examples of hardware and software arrangements for implementing the processes and functions of the disclosure, the sections below provide details and examples of arrangements for management of separated synchronization signals. One or more WD 22 functions described below may be performed by one or more of processing circuitry 84, WD management unit 34, radio interface 82, processor 86, etc. One or more network node 16 functions described below may be performed by one or more of processing circuitry 68, processor 70, NN management unit 32, radio interface 62, etc.

### High-Level System Operation

In some embodiments, a method in WD 22 (e.g., in a stand-alone system) is described, where the WD 22 is configured with a first synchronization signal (SS) configuration for idle mode and a first broadcasted system information. The first SS and/or configuration may be referred to as SSI. Using the first synchronization signal SSI and system information, the WD 22 accesses the network (e.g., NN 16). The WD 22 is then configured with (or obtains) at least one second synch configuration for connected mode (e.g., SSC) and second system information while in connected mode for operation in a serving cell 18. The WD 22 may be additionally provided with synchronization signal configurations, for neighbor cell-related operations (e.g., SSN or additional SSCs). As used herein, additional synchronization signal configurations may be referred to as SSCs. The WD 22 may be provided with multiple SSCs, possibly with different signals designs/parameters and for different intended purposes.

In some embodiments, SSCs are self-sustaining and/or without necessary/mandatory dependency/relationship (e.g., QCL relation) to the first synch signal. The SSCs may either be self-sustainable or have a relation, e.g., QCL, to each other. In some other embodiments, there may be a QCL property between any of the aforementioned transmitted signal (including between the SSC and the SSI), and the WD 22 may be informed about such relations by the NN 16 or based on specifications in case there can be optimizations by the WDs 22 for receiving the signals, but not such that there is a mandatory requirement (to the extent that an SSC cannot exist without an SSI).

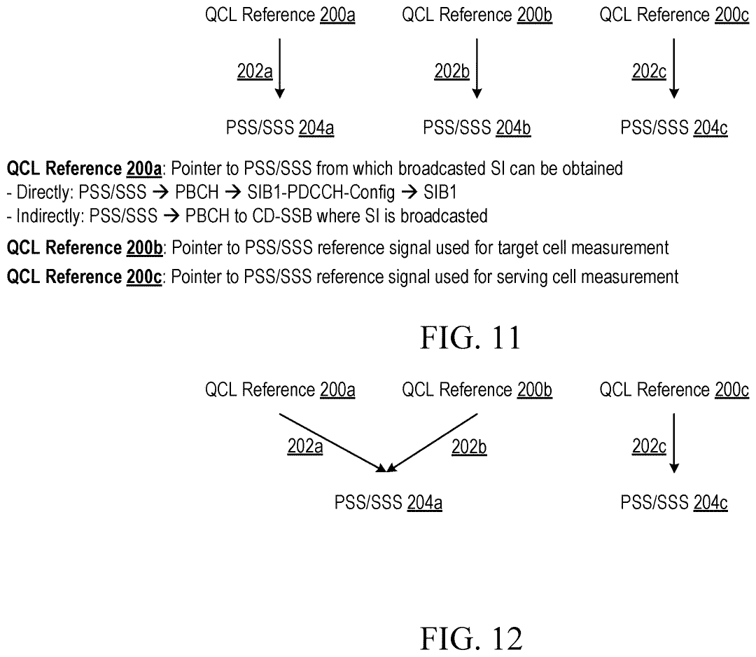

FIGS. 11-14 illustrate examples of such QCL relations. QL references 200a, 200b, 200c (collectively referred to as QL reference 200), pointers 202a, 202b, 202c (collectively referred to as pointers 202), and synchronization signals (SSs) 204a, 204b, 204c (collectively referred to as synchronization signals 204) such as PSS/SSS are shown. For example, as shown on FIG. 11, QCL Reference 200a may be mapped to a SSs 204a (PSS/SSS) via a pointer 202a. SI may be obtained from the SSs 204a (PSS/SSS). PSS/SSS may be associated with PBCH, which may be associated with a system information block (SIB) configuration such as SIB1-physical downlink control channel (PDCCH)-Config, which may be associated with a first SIB (SIB1). Alternatively, PSS/SSS may be associated with physical broadcast channel (PBCH) to cell defining SSB (CD-SSB) where SI is broadcasted. QCL Reference 200b may be mapped to SS204b, where PSS/SSS reference signal may be used for target cell measurement. QCL Reference 200c may be mapped to SS204c via pointer 202c, where PSS/SSS reference signal may be used for serving cell measurement. Further, the embodiment shown on FIG. 11 may be related to advanced use cases, distributed multiple input multiple output (D-MIMO), multi-transmission reception point (TRP), layer 1 (L1) mobility, virtual cells, etc.

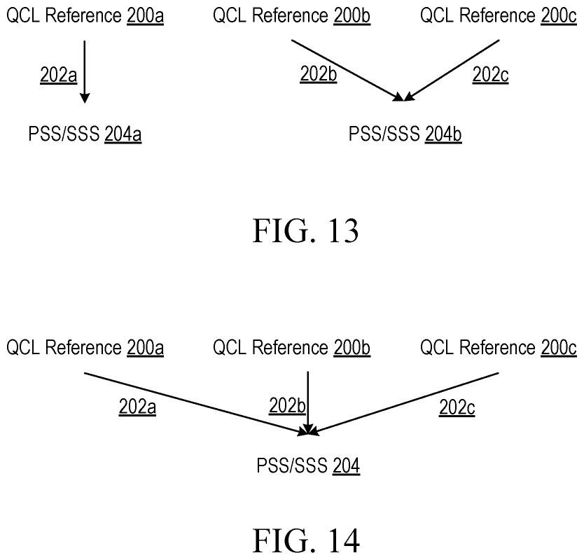

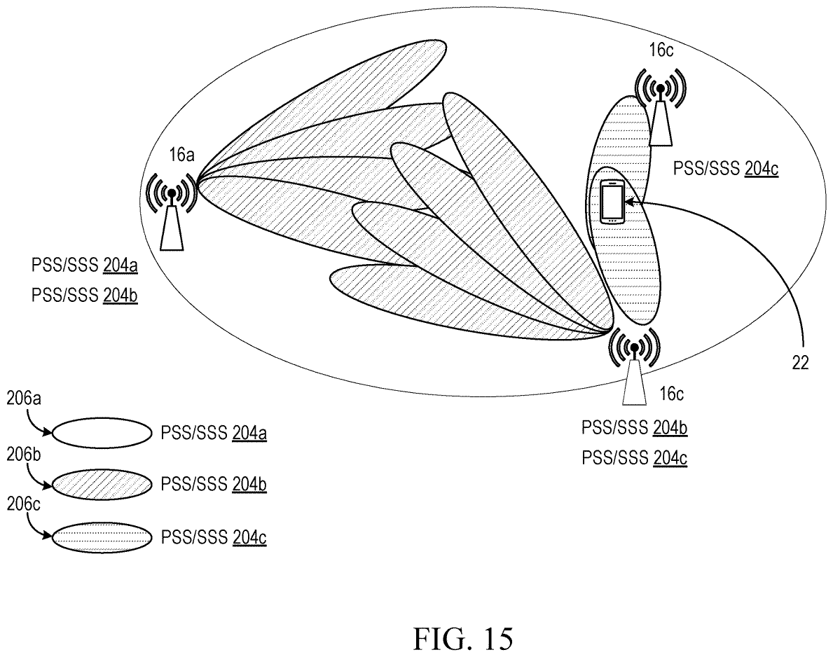

FIG. 12 shows QCL references 200a, 200b pointing to SS 204a (PSS/SSS) via pointers 202a, 202b. QCL reference 200c points to SS 204c (PSS/SSS) via pointer S202c. FIG. 13 shows QCL references 200b, 200c pointing to SS 204b (PSS/SSS) via pointers 202b, 202c. QCL reference 200a points to SS 204a (PSS/SSS) via pointer S202a. The embodiment shown in FIG. 13 may be used for separately connected devices and idle mode optimization, where SFN-transmission of broadcast from a subset of network nodes 16 is made, and may be associated with CD-SSB and NCD-SSB. FIG. 14 shows each one of QCL references 200a, 200b, 200c pointing to a SS 204 (PSS/SSS) via pointers 202a, 202b, 202c, respectively. The embodiment of FIG. 13 may be used with legacy systems, e.g., for single omni-cell with no neighbors.

In one example, the first configuration, SSI, configures a conventional, NR SSB-like signal, including a PSS, SSS, and a PBCH/MIB field that further points to broadcasted SI that may contain information required to perform initial network access. The SSI configuration may be provided by the network (e.g., NN 16) (e.g., in Subscriber Identity Module (SIM) or via broadcast) before the WD 22 enters the connected mode or based on a specification.

In one example, the second synchronization configuration, e.g., Synchronization Signal for Connected mode (SSC) or Synchronization Signal Block for Connected mode (SSBC), is provided by the network (e.g., NN 16) after the WD 22 enters the connected mode (or in another example, for WD 22 to utilize after it enters connected mode). For the description below, the term SSC will be used. Optionally, any of the configurations may be provided in system information, which may not be the first system information that the WD 22 reads. In 5G, the terminology is “necessary system information” and “remaining system information.” A reason for such division may be that, in some cases, the first SI only carries essential information for initial access. At other frames or via request, WD 22 may receive further system information. Another reason to provide SSC configuration via further system information may be that, after initial access, WD 22 may move to such a node faster.

In one example, the second set of synchronization and/or system information are specific to connected mode operations. As such, the WD 22 operating in connected mode acquires necessary synchronization and information for connected mode operation from the second set.

In another example, WD 22, accesses a network (e.g., NN 16) in idle mode using a first synchronization signal (SSI, SS for idle) and first system information. The WD 22 may also obtain, for connected mode operation, one or more additional synch signal configurations that are self-sustaining and/or without necessary/mandatory dependency/relationship (e.g., QCL relation) to the first synch signal, and receive in connected mode, one or more additional synch signal according to the synch signal configurations.

Similar to the SSB (SSI) MIB/PBCH, the SSCs may be accompanied by an information block. Different types of SSCs (for different purposes) may be equipped with different types of purpose-specific information blocks. For example, an SSC for connected mode link management and channel reception may be equipped with cell timing information and certain cell/channel resource configurations (or configuration pointers), while an SSC for neighbor cell measurement (SSN) may include the neighbor cell ID and timing information. Other types of information are not precluded, such as pointers to other SSs or relation (e.g., QCL or QCL-alike) information, or other types of cell configurations.

In one or more embodiments, the SSC configuration may be a logical entity that may refer to one of several possible physically transmitted SSC signals or any other type of signals.

### SSC Physical Signal Design

In some embodiments, the SSC physical signal can be an SSB or equivalent.

In some other embodiments, the SSC physical signal may be a subset of SSB, e.g., PSS or SSS, or a smaller PBCH, or a new synch signal, e.g., with its own signatures, sequences, interleaving pattern, TCI state of beam indices, etc.

In some embodiments, the SSC physical signal may be a CSI-RS, e.g., CSI-RS for tracking, or a new synch signal, e.g., with its own signatures, sequences, interleaving pattern, TCI state of beam indices, etc.

The detailed design of SSC physical signal options can be pre-configured and known to the WD 22 in advance, or alternatively, the WD 22 can know how (e.g., obtain information about how) SSC is designed as part of the received configuration.

FIG. 15 shows an example of how such SSCs can be configured. Network nodes 16a, 16b, 16c are shown, any of which may be configured to communicate with WD 22. For example, network node 16a may be configured to communicate using beams or cells 206a, 206b, network node 16b may be configured to communicate using beams or cells 206b, 206c, and network node 16c may be configured to communicate using beams or cells 206c. Further, beam or cell 206a may correspond to and/or may be used to transmit SS204a (PSS1/SSS1), beam or cell 206b may correspond to and/or may be used to transmit SS204b (PSS2/SSS2), and beam or cell 206c may correspond to and/or may be used to transmit SS204c (PSS3/SSS3). In addition, SS 204 may be assigned to different beams 206 (or cells) such as shown on Table 1.

TABLE 1
SS assignments.

| “Broadcast” | “Target” | “Serving” | Notes |
|---|---|---|---|
| PSS/SSS 204a | PSS/SSS 204b | PSS/SSS 204c | |
| | PSS/SSS 204b | PSS/SSS 204c | Node with no idle |
| | | | mode |
| | | | responsibility. |
| | | | Active “virtual |
| | | | cell” |
| | | PSS/SSS 204c | Node or cell only |
| | | | visible to served |
| | | | WDs 22. No |
| | | | incoming handover |
| | | | or UL handover |
| PSS/SSS 204a | PSS/SSS 204b | | Node with idle |
| | | | mode |
| | | | responsibility. DL |
| | | | mobility pilots |
| | | | active. |
| PSS/SSS 204a | | PSS/SSS 204c | Node with idle |
| | | | mode |
| | | | responsibility. |
| | | | Active virtual cell |
| | | | or dedicated |
| | | | bandwidth part. |

Coordinated design may be used to maximize discontinuous transmission (DTX). In some embodiments, beams or cells 206a, 206b, 206c (collectively referred to as beams or cells 206 may refer to or be associated with cells 18). In this nonlimiting example, PSS1/SSS1 is the legacy or first synch signal, and PSS2/SSS2 and PSS3/SSS3 are examples of SSC.

### SSC Configuration

In some embodiments, SSC is WD-specifically configured for serving or non-serving cell 18, e.g., using dedicated RRC signaling. For example, the WD 22 receives the configuration of SSC through RRC signaling, or other types of WD 22-specific configuration mechanisms.

In some other embodiments, the SSC configuration includes explicit signal configuration information, e.g., the SS physical signal format/design/fields and related configuration parameters (time and/or frequency (T/F) resources, allocated codes or sequence seeds, sub-carrier spacing, etc.).

In some embodiments, the SSC configuration includes a reference to a previously provided configuration/information, e.g., the SSI configuration/information obtained by the WD 22 before entering connected mode.

In some other embodiments, the SSC configuration may be provided in two stages. In the first stage, multiple SSC configuration options may be provided, e.g., via RRC signaling, or via subsequent system information. In the second stage, the WD 22 may receive an indication of which of the options should be used for the SSC purpose, e.g., via medium access control (MAC) control element (CE) or downlink control information (DCI) signaling or during initial access procedure such as in Msg2 or Msg4.

In some embodiments, the WD 22 receives a configuration in order to dynamically switch between different reference signals (RSs) or synchronization signals, e.g., at a specific time, this RS is SSB, or SSC or other RSs. For example, certain SSs (any of SSI or SSCs) can be used for other purposes, e.g., the SSI may perhaps also be used for link/channel processing in connected mode, or SSC can be used for connected mode RRM/RLM. Furthermore, the NN 16 may have configured the SSI/SSCs to be periodically/semi-persistently transmitted. If some of the transmission occasions are overlapping/adjacent in time, it may be wasteful/feasible for the NN 16 to transmit both. As such, the NN 16 may then provide configuration/indication to the WD 22 about temporal usage of certain SSs for certain purposes. The configuration/indication may be one-shot, semi-persistent or periodic with time-table-alike and/or with masking/precedence/priority and purpose information. For example, NN 16 informs the WD 22 that overlapping or adjacent SSI occasions are to mask out the SSC occasions and inherit or not inherit the purpose of that SSC occasion.

In some embodiments, SSC is one, or combination of periodic/semi-static/or aperiodic signals/channels/components. For example, SSC may be designed to be periodic, semi-static or semi-persistent and/or such that it can be activated or deactivated using L1/L2 signaling, e.g., DCI or MAC-CE. Alternatively, it can be designed to be always aperiodic (or on demand), e.g., an L1 mechanism such as DCI (or an L2 MAC-CE) is used in order to trigger SSC whenever needed.

In some other embodiments, the WD 22 may be configured with a first periodic SSC component and a second aperiodic component which in a nonexclusive example, each of those SSCs of the serving cell 18 can be configured for different purposes. For example, the first SSC may be intended for serving cell measurements while the second SSC is intended for mobility measurements.

In some embodiments, SSC can be WD 22 specifically beamformed, i.e., SSC can be transmitted in beam configurations which are different between the WDs 22. This is different from the conventional SSBs which are broadcasted to all the WDs 22 within the same beam configuration.

In some other embodiments, SSC has at least one configuration/configuration parameter/attribute which is different from SSB, e.g., in terms of QCL. As mentioned above, beams associated to SSC can be configured to be WD specific, e.g., using TCI state. In other examples, SSC has a different BWP than SSB, e.g., is not configured in the initial BWP. In another example, SSC has a different periodicity than SSB (if configured to be periodic). In some embodiments, SSC may be configured with a power offset parameter indicating its offset to a SSB or another synchronization signal, e.g., another SSC. In some other embodiments, CSI-RS for CSI measurement/reporting may be configured with a power offset parameter indicating its power offset (or PDSCH power offset) relative to an SSC.

### Use of SSC by WD 22

In some embodiments, the SSC may be intended to be used for mobility measurements. The WD 22 may perform RSRP or other signal quality measurements on the serving and non-serving cells 18 using SSC.

In some embodiments, the network knows that the WD 22 is stationary or in part stationary or slow moving and thus periodic measurements may be rather redundant and low-rate or occasional aperiodic measurements may be configured for such a WD 22. Further, the SSC may have correspondingly long period or infrequent occasions. Alternatively, the WD 22 may be fast moving, e.g., in a train, and thus it makes sense to perform more frequent mobility measurements, and thus SSC for this WD 22 is configured periodically and configured with a sufficiently short period.

In some embodiments, the WD 22 may provide assistance to the network (e.g., NN 16) related to SSC provision, such as an SSC transmission rate directly or indirectly based on provided information about WD 22 speed or alike. Other types of assistance may be related to SSC transmission occasions such as time offset from the system time (e.g., system frame number or offset to another reference point). The WD 22 may further request (or trigger a report such that) the serving NN 16 ensures that a neighbor cell 18 starts transmission of neighbor cell SSC (SSN) for measurements.

As exemplified above, in some embodiments, SSC is used for serving/non-serving cell mobility measurements while in connected mode. In other embodiments, the SSC for serving cell measurements is different from the mobility measurements, or other purposes, e.g., RRM, RLM, BFD. For example, the WD 22 may receive a configuration of SSC with refined beams for BFD, while wider beams for an SSC are used for RLM, or RRM.

In one example, the SSC may be intended to use for CSI collection, for BM, etc.

The following is a nonlimiting list of example embodiments.

Embodiment A1. A wireless device (WD) configured to communicate with a network node, the WD and the network node being comprised in a network, the WD configured to, and/or comprising a radio interface and/or processing circuitry configured to one or more of:
access the network during idle mode and/or cell search and/or cell detection and/or initial access using a first synchronization signal and first system information at least to enter a connected mode;
upon the WD entering the connected mode, receive one or more additional synchronization signal configurations:
   that are self-sustaining; or
   without one or both of a mandatory dependency and a mandatory relationship to the first synchronization signal; and
perform one or more actions based on the one or more additional synchronization signal configurations.

Embodiment A2. The WD of Embodiment A1, wherein at least one of the one or more additional synchronization signal configurations is included at least in part in the first system information.

Embodiment A3. The WD of any one of Embodiments A1 and A2, wherein one or both of:
the one or more actions include performing measurements associated with one or both of a serving cell and a neighbor cell while in the connected mode and using at least one of the one more additional synchronization signal configurations; and
the WD is further configured to perform another action associated with the cell search and the cell detection.

Embodiment A4. The WD of Embodiment A3, wherein the measurements associated with the neighbor cell are based on neighbor cell synchronization signals including one of a first neighbor cell synchronization signal or an additional neighbor cell synchronization signal.

Embodiment A5. The WD of any one of Embodiments A1-A4, wherein at least one of the one or more additional synchronization signal configurations includes a pointer to a previously provided synchronization signal configuration or a separate synchronization signal configuration.

Embodiment A6. The WD of any one of Embodiments A1-A5, wherein one or more of:
the self-sustaining is related to independent QCL relations;
the one or more additional synchronization signal configurations are without one or both of necessary dependency and necessary relationship to the first synchronization signal;
the one or more additional signal configurations include another QCL relation to the first synch signal;
the WD is further configured to determine a QCL property between the first synchronization signal and the one or more additional synchronization signal configurations; and/or
the WD is further configured to receive an indication indicating one or more of the independent QCL relations, the other QCL relation, the QCL property, the one or more additional synchronization signal configurations are without one or both of the necessary dependency and the necessary relationship to the first synchronization signal, the one or more additional synchronization signal configurations are without one or both of the mandatory dependency and the mandatory relationship to the first synchronization signal.

Embodiment A7. The WD of any one of Embodiments A1-A6, wherein one or more of:
the WD is further configured to receive a second configuration to dynamically switch between different reference signals or one or more synchronization signals;
the different reference signals include a synchronization signal block (SSB), the one or more additional synchronization signal configurations, and other reference signals;
the first synchronization signal is usable for link and/or channel processing in the connected mode;
the one or more synchronization signal configurations are usable for radio resource management and/or radio link monitoring;
the first synchronization signal and/or the one or more synchronization signal configurations are periodically and/or semi-persistently transmitted by the network node;
the WD is further configured to receive an indication about temporal usage of a group of synchronization for a predetermined purpose;
the indication is one-shot, semi-persistent, or periodic with time-table-alike and/or with masking and/or precedence and/or priority and/or predetermined purpose information; and/or
the indication indicates that overlapping or adjacent first synchronization signal occasions are to mask out synchronization signal configuration occasions and inherit or not inherit the predetermined purpose of the corresponding synchronization signal configuration occasion.

Embodiment A8. The WD of any one of Embodiments A1-A7, wherein:
the WD accesses the network via the network node; and
the WD is further configured to receive a first synchronization signal configuration and the one or more additional synchronization signal configurations from the network node.

Embodiment B1. A method in a wireless device (WD) configured to communicate with a network node, the WD and the network node being comprised in a network, the method comprising one or more of:
accessing the network during idle mode and/or cell search and/or cell detection and/or initial access using a first synchronization signal and first system information at least to enter a connected mode;
upon entering the connected mode, receiving one or more additional synchronization signal configurations:
   that are self-sustaining; or
   without one or both of a mandatory dependency and a mandatory relationship to the first synchronization signal; and
performing one or more actions based on the one or more additional synchronization signal configurations.

Embodiment B2. The method of Embodiment B1, wherein at least one of the one or more additional synchronization signal configurations is included at least in part in the first system information.

Embodiment B3. The method of any one of Embodiments B1 and B2, wherein one or both of:
the one or more actions include performing measurements associated with one or both of a serving cell and a neighbor cell while in the connected mode and using at least one of the one more additional synchronization signal configurations; and
the method further includes performing another action associated with the cell search and the cell detection.

Embodiment B4. The method of Embodiment B3, wherein the measurements associated with the neighbor cell are based on neighbor cell synchronization signals including one of a first neighbor cell synchronization signal or an additional neighbor cell synchronization signal.

Embodiment B5. The method of any one of Embodiments B1-B4, wherein at least one of the one or more additional synchronization signal configurations includes a pointer to a previously provided synchronization signal configuration or a separate synchronization signal configuration.

Embodiment B6. The method of any one of Embodiments B1-B5, wherein one or more of:
the self-sustaining is related to independent QCL relations;
the one or more additional synchronization signal configurations are without one or both of necessary dependency and necessary relationship to the first synchronization signal;
the one or more additional signal configurations include another QCL relation to the first synch signal;
the method further includes determining a QCL property between the first synchronization signal and the one or more additional synchronization signal configurations; and/or
the method further includes receiving an indication indicating one or more of the independent QCL relations, the other QCL relation, the QCL property, the one or more additional synchronization signal configurations are without one or both of the necessary dependency and the necessary relationship to the first synchronization signal, the one or more additional synchronization signal configurations are without one or both of the mandatory dependency and the mandatory relationship to the first synchronization signal.

Embodiment B7. The method of any one of Embodiments B1-B6, wherein one or more of:
the method further includes receiving a second configuration to dynamically switch between different reference signals or one or more synchronization signals;
the different reference signals include a synchronization signal block (SSB), the one or more additional synchronization signal configurations, and other reference signals;
the first synchronization signal is usable for link and/or channel processing in the connected mode;
the one or more synchronization signal configurations are usable for radio resource management and/or radio link monitoring;
the first synchronization signal and/or the one or more synchronization signal configurations are periodically and/or semi-persistently transmitted by the network node;
the method further includes receiving an indication about temporal usage of a group of synchronization for a predetermined purpose;
the indication is one-shot, semi-persistent, or periodic with time-table-alike and/or with masking and/or precedence and/or priority and/or predetermined purpose information; and/or
the indication indicates that overlapping or adjacent first synchronization signal occasions are to mask out synchronization signal configuration occasions and inherit or not inherit the predetermined purpose of the corresponding synchronization signal configuration occasion.

Embodiment B8. The method of any one of Embodiments B1-B7, wherein:
the WD accesses the network via the network node; and
the WD is further configured to receive a first synchronization signal configuration and the one or more additional synchronization signal configurations from the network node.

Embodiment C1. A network node configured to communicate with a wireless device (WD), the WD and the network node being comprised in a network, the network node configured to, and/or comprising a radio interface and/or comprising processing circuitry configured to:
determine one or both of a first synchronization signal and one or more additional synchronization signal configurations based on one or more parameters, the one or more additional synchronization signal configurations are self-sustaining or do not include one or both of a mandatory dependency and a mandatory relationship to a first synchronization signal; and
upon determining that the WD has entered a connected mode, cause transmission of the one or more additional synchronization signal configurations to the WD.

Embodiment C2. The network node of Embodiment C1, wherein the WD accesses the network during idle mode and/or cell search and/or cell detection and/or initial access using the first synchronization signal and first system information at least to enter the connected mode, and at least one of the one or more additional synchronization signal configurations is included at least in part in the first system information.

Embodiment C3. The network node of any one of Embodiments C1 and C2, wherein one or both of:
the transmission of the one or more additional synchronization signal configurations triggers the WD to perform measurements associated with one or both of a serving cell and a neighbor cell while in the connected mode and using at least one of the one more additional synchronization signal configurations; and
the WD is further configured to perform an action associated with the cell search and the cell detection.

Embodiment C4. The network node of Embodiment C3, wherein the measurements associated with the neighbor cell are based on neighbor cell synchronization signals including one of a first neighbor cell synchronization signal or an additional neighbor cell synchronization signal.

Embodiment C5. The network node of any one of Embodiments C1-C4, wherein at least one of the one or more additional synchronization signal configurations includes a pointer to a previously provided synchronization signal configuration or a separate synchronization signal configuration.

Embodiment C6. The network node of any one of Embodiments C1-C5, wherein one or more of:
the self-sustaining is related to independent QCL relations;
the one or more additional synchronization signal configurations are without one or both of necessary dependency and necessary relationship to the first synchronization signal;
the one or more additional signal configurations include another QCL relation to the first synch signal;
the network node is configured to cause the WD to determine a QCL property between the first synchronization signal and the one or more additional synchronization signal configurations; and/or
the network node is further configured to transmit an indication indicating one or more of the independent QCL relations, the other QCL relation, the QCL property, the one or more additional synchronization signal configurations are without one or both of the necessary dependency and the necessary relationship to the first synchronization signal, the one or more additional synchronization signal configurations are without one or both of the mandatory dependency and the mandatory relationship to the first synchronization signal.

Embodiment C7. The network node of any one of Embodiments C1-C6, wherein one or more of:
the network node is further configured to transmit a second configuration to dynamically switch between different reference signals or one or more synchronization signals;
the different reference signals include a synchronization signal block (SSB), the one or more additional synchronization signal configurations, and other reference signals;
the first synchronization signal is usable for link and/or channel processing in the connected mode;
the one or more synchronization signal configurations are usable for radio resource management and/or radio link monitoring;
the first synchronization signal and/or the one or more synchronization signal configurations are periodically and/or semi-persistently transmitted by the network node;
the network node is further configured to transmit an indication about temporal usage of a group of synchronization for a predetermined purpose;
the indication is one-shot, semi-persistent, or periodic with time-table-alike and/or with masking and/or precedence and/or priority and/or predetermined purpose information; and/or
the indication indicates that overlapping or adjacent first synchronization signal occasions are to mask out synchronization signal configuration occasions and inherit or not inherit the predetermined purpose of the corresponding synchronization signal configuration occasion.

Embodiment C8. The network node of any one of Embodiments C1-C7, wherein:
the WD accesses the network via the network node; and
the network node is further configured to transmit a first synchronization signal configuration and the one or more additional synchronization signal configurations to the WD.

Embodiment D1. A method in a network node configured to communicate with a wireless device (WD), the WD and the network node being comprised in a network, the method comprising:
determining one or both of a first synchronization signal and one or more additional synchronization signal configurations based on one or more parameters, the one or more additional synchronization signal configurations are self-sustaining or do not include one or both of a mandatory dependency and a mandatory relationship to a first synchronization signal; and
upon determining that the WD has entered a connected mode, transmitting the one or more additional synchronization signal configurations to the WD.

Embodiment D2. The method of Embodiment D1, wherein the WD accesses the network during idle mode and/or cell search and/or cell detection and/or initial access using the first synchronization signal and first system information at least to enter the connected mode, and at least one of the one or more additional synchronization signal configurations is included at least in part in the first system information.

Embodiment D3. The method of any one of Embodiments D1 and D2, wherein one or both of:
the transmission of the one or more additional synchronization signal configurations triggers the WD to perform measurements associated with one or both of a serving cell and a neighbor cell while in the connected mode and using at least one of the one more additional synchronization signal configurations; and
the WD is further configured to perform an action associated with the cell search and the cell detection.

Embodiment D4. The method of Embodiment D3, wherein the measurements associated with the neighbor cell are based on neighbor cell synchronization signals including one of a first neighbor cell synchronization signal or an additional neighbor cell synchronization signal.

Embodiment D5. The method of any one of Embodiments D1-D4, wherein at least one of the one or more additional synchronization signal configurations includes a pointer to a previously provided synchronization signal configuration or a separate synchronization signal configuration.

Embodiment D6. The method of any one of Embodiments D1-D5, wherein one or more of:
the self-sustaining is related to independent QCL relations;
the one or more additional synchronization signal configurations are without one or both of necessary dependency and necessary relationship to the first synchronization signal;
the one or more additional signal configurations include another QCL relation to the first synch signal;
the method further includes causing the WD to determine a QCL property between the first synchronization signal and the one or more additional synchronization signal configurations; and/or
the method further includes transmitting an indication indicating one or more of the independent QCL relations, the other QCL relation, the QCL property, the one or more additional synchronization signal configurations are without one or both of the necessary dependency and the necessary relationship to the first synchronization signal, the one or more additional synchronization signal configurations are without one or both of the mandatory dependency and the mandatory relationship to the first synchronization signal.

Embodiment D7. The method of any one of Embodiments D1-D6, wherein one or more of:
the method further includes transmitting a second configuration to dynamically switch between different reference signals or one or more synchronization signals;
the different reference signals include a synchronization signal block (SSB), the one or more additional synchronization signal configurations, and other reference signals;
the first synchronization signal is usable for link and/or channel processing in the connected mode;
the one or more synchronization signal configurations are usable for radio resource management and/or radio link monitoring;
the first synchronization signal and/or the one or more synchronization signal configurations are periodically and/or semi-persistently transmitted by the network node;
the method further includes transmitting an indication about temporal usage of a group of synchronization for a predetermined purpose;
the indication is one-shot, semi-persistent, or periodic with time-table-alike and/or with masking and/or precedence and/or priority and/or predetermined purpose information; and/or
the indication indicates that overlapping or adjacent first synchronization signal occasions are to mask out synchronization signal configuration occasions and inherit or not inherit the predetermined purpose of the corresponding synchronization signal configuration occasion.

Embodiment D8. The method of any one of Embodiments D1-D7, wherein:
the WD accesses the network via the network node; and
the network node is further configured to transmit a first synchronization signal configuration and the one or more additional synchronization signal configurations to the WD.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a wireless device, WD, configured to communicate with a network node, the WD and the network node being comprised in a network, the method comprising:
accessing the network while one or both of the WD is in idle mode and the access is an initial access, accessing the network being performed using a first synchronization signal, SS, and first system information associated with a first SS configuration, SSI, at least to enter a connected mode;
upon the WD entering the connected mode, obtaining one or more additional synchronization signal configurations, SSCs, that are one or both of self-sustaining and without a mandatory dependency and a mandatory relationship to one or both of the first SS and the SSI; and
performing one or more actions based on the one or more SSCs.

2. The method of claim 1, wherein at least one of the one or more SSCs is included at least in part in the first system information.

3. The method of claim 1, wherein one or more of:
the network is further accessed while one or both of a cell search is being performed by the WD and cell detection is being performed by the WD;
the one or more actions include performing measurements associated with one or both of a serving cell and a neighbor cell while in the connected mode and using at least one of the one more SSCs;
the WD is further configured to perform another action associated with the cell search and the cell detection; and
the measurements associated with the neighbor cell are based on neighbor cell synchronization signals including one of a first neighbor cell synchronization signal or an additional neighbor cell synchronization signal.

4. The method of claim 1, wherein at least one of the one or more SSCs includes a pointer to a previously provided synchronization signal configuration or a separate synchronization signal configuration.

5. The method of claim 1, wherein the self-sustaining is related to one or more independent QCL relations.

6. The method of claim 1, wherein one or more of:
the SSI configures a synchronization signal, SS;
the SS includes one or both of a primary SS, PSS, and a secondary SS, SSS;
the SSI includes a field that points to broadcasted system information that includes information for performing the initial access; and
the field is a one or both of a physical broadcast channel and a management information block field.

7. The method of claim 1, wherein one or both of:
obtaining the one or more SSCs includes receiving the one or more SSCs from the network node; and
obtaining the one or more SSCs includes obtaining the one or more SSCs from additional system information other than the first system information.

8. The method of claim 1, wherein one or both of:
obtaining the one or more SSCs includes obtaining second system information;
the one or more SSCs and the second system information correspond to connected mode operations.

9. The method of claim 1, wherein at least one of the one or more SSCs include an information block.

10. The method of claim 1, wherein one or more of:
the one or more SSCs are associated with one or more physical signals;
the one or more physical signals include a subset of a synchronization signal block, SSB;
the subset includes one or more of a PSS, an SSS, and a physical broadcast channel; and
the one or more physical signals include a channel state information reference signal, CSI-RS.

11. The method of claim 1, wherein at least one of the SSCs one or more of:
is configured for a serving cell or a non-serving cell;
includes explicit signal configuration information;
includes a reference to the SSI;
is obtained in a first stage and a second stage, in the first stage, multiple SSC configuration options are obtained, in the second stage, the obtaining includes receiving an indication indicating one or more of the multiple SSC configuration options;
is one of periodic, semi-static, and semi-persistent; and
is beamformed.

12. The method of claim 1, wherein performing the one or more actions include one or more of:
performing a mobility measurement based on at least one of the one or more SSCs;
performing reference signal received power, RSRP, measurement based on the at least one of the one or more SSCs;
performing periodic measurements based on a mobility parameter of the WD; and
transmitting to the network node assistance information related to SSC provisioning.

13. A wireless device, WD, configured to communicate with a network node, the WD and the network node being comprised in a network, the WD configured to:
access the network while one or both of the WD is in idle mode and the access is an initial access, accessing the network being performed using a first synchronization signal, SS, and first system information associated with a first SS configuration, SSI, at least to enter a connected mode;
upon the WD entering the connected mode, obtain one or more additional synchronization signal configurations, SSCs, that are one or both of self-sustaining and without a mandatory dependency and a mandatory relationship to one or both of the first SS and the SSI; and
perform one or more actions based on the one or more SSCs.

14. A method in a network node configured to communicate with a wireless device, WD, the WD and the network node being comprised in a network, the method comprising:
determining one or both of a first synchronization signal, SS, configuration, SSI, and one or more additional SS configurations, SSCs, based on one or more parameters, the SSI being associated with a first SS and first system information used by the WD to access the network while one or both of the WD is in idle mode and the access is an initial access, the accessing of the network being performed to enter a connected mode, the one or more SSCs being self-sustaining or without one or both of a mandatory dependency and a mandatory relationship to one or both of the first SS and the SSI; and
upon determining that the WD has entered a connected mode, causing transmission of the one or more SSCs to the WD.

15. The method of claim 14, wherein at least one of the one or more SSCs is included at least in part in the first system information.

16. The method of claim 14, wherein at least one of the one or more SSCs includes a pointer to a previously provided synchronization signal configuration or a separate synchronization signal configuration.

17. The method of claim 14, wherein the self-sustaining is related to one or more independent QCL relations.

18. The method of claim 14, wherein one or more of:
the network is further accessed while one or both of a cell search is being performed by the WD and cell detection is being performed by the WD;
the SSI configures a synchronization signal, SS;
the SS includes one or both of a primary SS, PSS, and a secondary SS, SSS;
the SSI includes a field that points to broadcasted system information that includes information for performing the initial access; and
the field is a one or both of a physical broadcast channel and a management information block field.

19. The method of claim 14, wherein the method further includes:
transmitting additional system information other than the first system information for the WD to obtain the one or more SSCs.

20.-24. (canceled)

25. A network node configured to communicate with a wireless device, WD, the WD and the network node being comprised in a network, the network node configured to:
determine one or both of a first synchronization signal, SS, configuration, SSI, and one or more additional SS configurations, SSCs, based on one or more parameters, the SSI being associated with a first SS and first system information used by the WD to access the network while one or both of the WD is in idle mode and the access is an initial access, the accessing of the network being performed to enter a connected mode, the one or more SSCs being self-sustaining or without one or both of a mandatory dependency and a mandatory relationship to one or both of the first SS and the SSI; and
upon determining that the WD has entered a connected mode, cause transmission of the one or more SSCs to the WD.
